(19) United States
(12) Patent Application Publication
(10) Pub. No.: US 2016/0300282 A1
(43) Pub. Date: Oct. 13, 2016

(54) SERVER FOR DETERMINING WHETHER REQUEST OFFER MATCHES FULFILMENT OFFER

(71) Applicants: Richard Andrew SUNDIN, Calgary (CA); Melanie Tiglao SUNDIN, Calgary (CA)

(72) Inventors: Richard Andrew SUNDIN, Calgary (CA); Melanie Tiglao SUNDIN, Calgary (CA)

(21) Appl. No.: 14/682,206

(22) Filed: Apr. 9, 2015

(51) Int. Cl. G06Q 30/06; H04W 4/02

(52) U.S. Cl. CPC G06Q 30/0611; H04W 4/023; G06Q 30/0639

(57) ABSTRACT

A server-operating method is for operating a server connectable to a network. The method instructs the server to: (A) determine whether a requester location of a requester-mobile device is within a distance from a fulfiller location of a fulfiller-mobile device; and (B) generate a match notification for display on the requester-mobile device for the case where: (i) the request offer from the requester-mobile device matches the fulfilment offer; and (ii) the requester location of the requester-mobile device is within the distance from the fulfiller location.

### TECHNICAL FIELD

This document relates to the technical field (and is not limited to) a server (and method therefor) configured to determine, via the Internet, whether a request offer that was received from a requester-mobile device matches a fulfilment offer that was received from a fulfiller-mobile device.

### BACKGROUND

Typically, when a consumer (also called a person or a requester) seeks products and/or services via the Internet, the consumer may consider operating a web browser, search for the product and/or service via an Internet search engine, and attempt to identify a suitable supplier (also called a fulfiller) of the product and/or service. For a supplier, advertising over the Internet is the typical way of directing the consumer to their product and/or service.

### SUMMARY

It will be appreciated that there exists a need to mitigate (at least in part) at least one problem associated with existing systems for matching the needs of a requestor (a consumer) with the offering of a fulfiller (a supplier or a provider). After much study of the known systems and methods with experimentation, an understanding of the problem and its solution has been identified and is articulated as follows:

Requestors (consumers) are busy people and would appreciate a less tedious way of finding products and/or services (simply because of the large amount of time involved in the search for the right product and/or solution). Fulfillers (suppliers or providers) would appreciate a more cost effective alternative to advertising simply because advertising generally does not target specific requestors that are ready to make a purchase.

To mitigate, at least in part, at least one problem associated with existing technology there is provided (in accordance with a major aspect) an apparatus. The apparatus includes a server connectable to a network. The server includes a processor assembly, and also includes a memory unit tangibly embodying processor-executable code configured to urge the processor assembly to: (A) receive, via the network, a request offer from a requester-mobile device; (B) receive, via the network, a fulfilment offer from a fulfiller-mobile device; (C) receive, via the network, a requester location of the requester-mobile device; (D) receive, via the network, a fulfiller location of the fulfiller-mobile device; (E) determine whether the requester location of the requester-mobile device is within a distance from the fulfiller location of the fulfiller-mobile device; (F) generate a match notification for display on the requester-mobile device for where: (i) the request offer from the requester-mobile device matches the fulfilment offer; and (ii) the requester location of the requester-mobile device is within the distance from the fulfiller location; and (G) transmit, via the network, the match notification that was generated for display to any one of the requester-mobile device and the fulfiller-mobile device.

To mitigate, at least in part, at least one problem associated with existing technology, there is provided (in accordance with a major aspect) a server-operating method for operating a server connectable to a network. The method instructs the server to: (A) receive, via the network, a request offer from a requester-mobile device; (B) receive, via the network, a fulfilment offer from a fulfiller-mobile device; (C) receive, via the network, a requester location of the requester-mobile device; (D) receive, via the network, a fulfiller location of the fulfiller-mobile device; (E) determine whether the requester location of the requester-mobile device is within a distance from the fulfiller location of the fulfiller-mobile device; (F) generate a match notification for display on the requester-mobile device for where: (i) the request offer from the requester-mobile device matches the fulfilment offer; and (ii) the requester location of the requester-mobile device is within the distance from the fulfiller location; and (G) transmit, via the network, the match notification that was generated for display to any one of the requester-mobile device and the fulfiller-mobile device.

Other aspects are identified in the claims.

Other aspects and features of the non-limiting embodiments may now become apparent to those skilled in the art upon review of the following detailed description of the non-limiting embodiments with the accompanying drawings.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 (SHEET 1 of 10 SHEETS) depicts a schematic view of an embodiment of a server-operating method of operating a server depicted in FIGS. 2A to 2C;

FIGS. 2A, 2B and 2C (SHEETS 2 to 4 of 10 SHEETS) depict schematic views of embodiments of a server connectable to a network, with the server configured to operate the server-operating method depicted in FIG. 1;

FIG. 3 (SHEET 5 of 10 SHEETS) depicts a schematic view of an embodiment of the server of any one of FIGS. 2A, 2B and 2C;

FIGS. 4A and 4B (SHEETS 6 and 7 of 10 SHEETS) depict schematic views of embodiments of devices associated with the server-operating method depicted in FIG. 1; and

FIGS. 5A, 5B and 5C (SHEETS 8 to 10 of 10 SHEETS) depict schematic views of an alternate embodiment of the server of any one of FIGS. 2A, 2B and 2C.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

102 requester-mobile device
104 match notification
106 distance
108 fulfiller-mobile device
200 requester location
202 fulfiller location
300 request offer
302 fulfilment offer
304 match notification
400 requester input device
402 fulfiller notification device
406 requester locator device
408 GPS satellite system
500 fulfiller input device
502 fulfiller notification device
504 touchscreens
506 fulfiller locator device
600 server-operating method
900 server
902 network
904 storage device
906 display
908 network connection device
910 input device

### DETAILED DESCRIPTION THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the invention is defined by the claims. For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

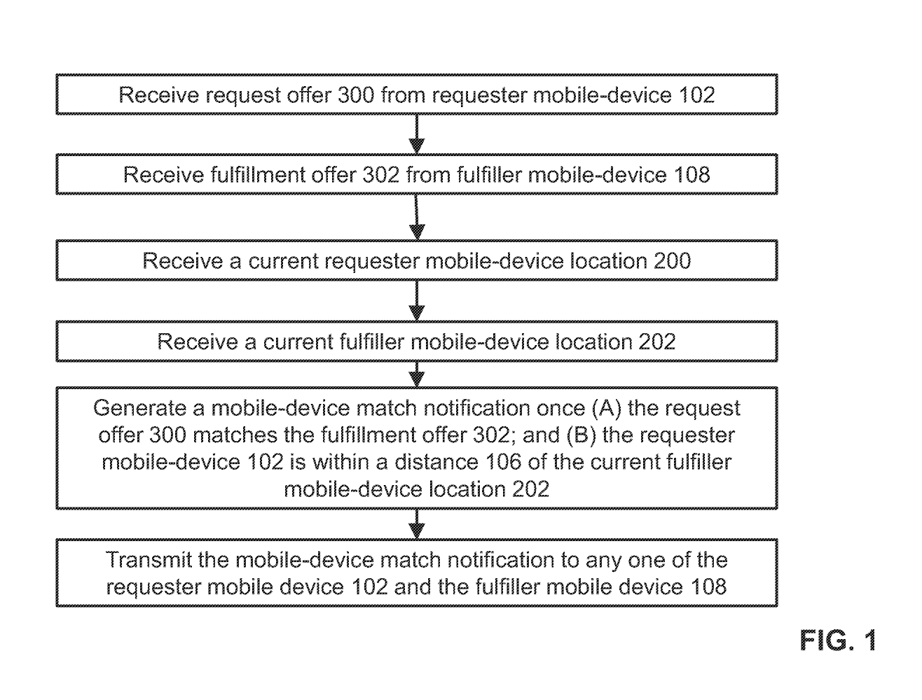

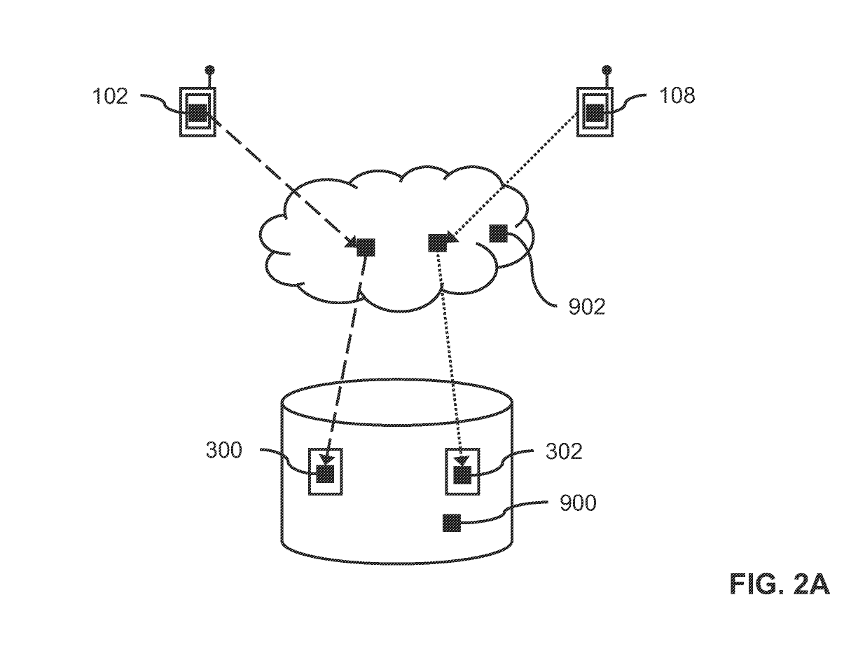

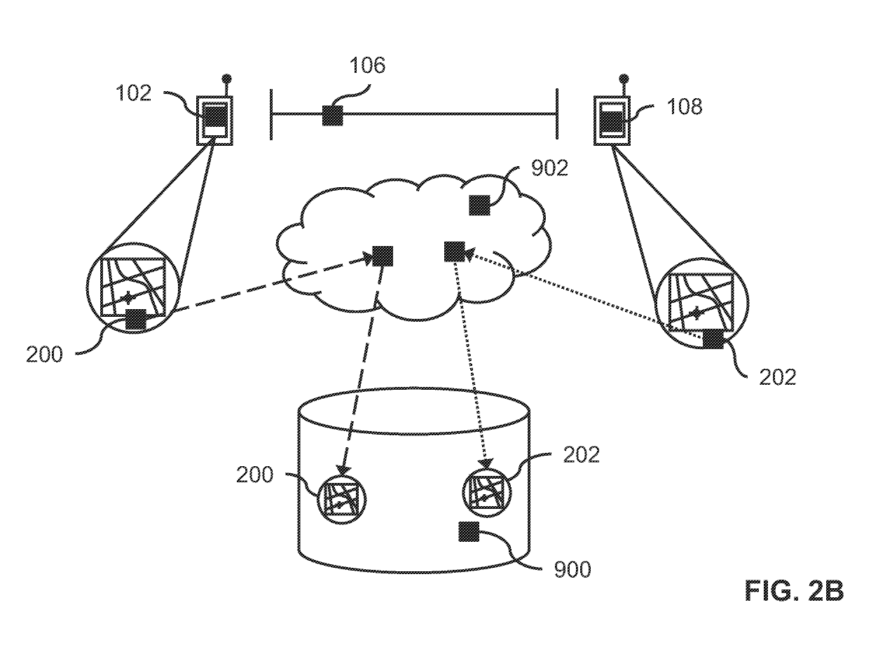

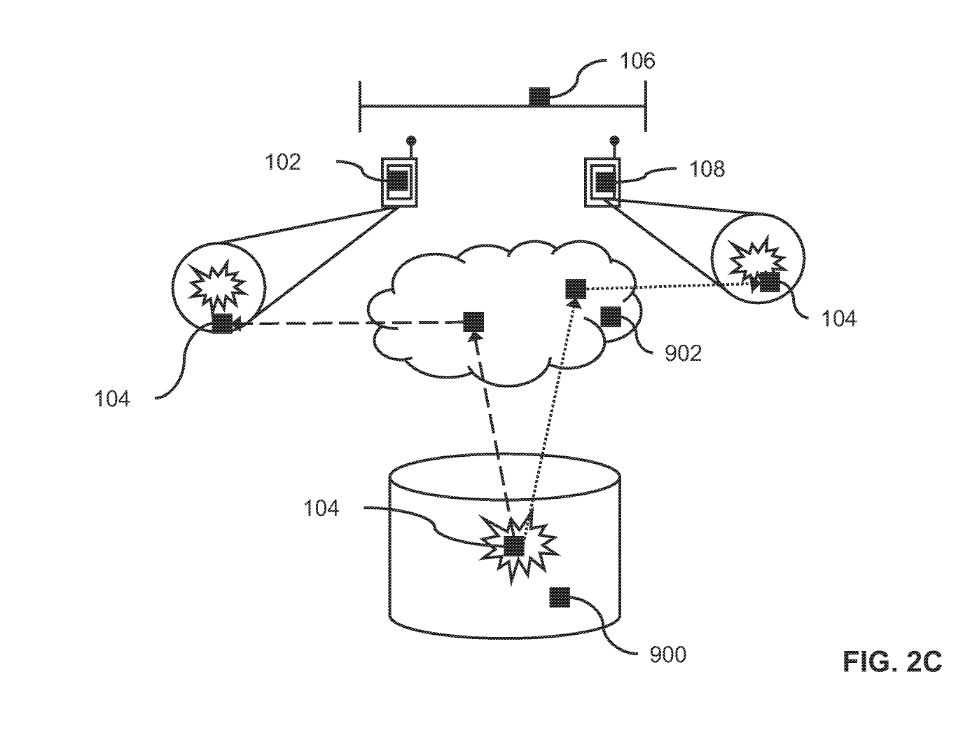

FIG. 1 depicts a schematic view of an embodiment of a server-operating method 600 of operating a server 900 depicted in FIGS. 2A to 2C.

FIGS. 2A, 2B and 2C depict schematic views of embodiments of the server 900 that is connectable to a network 902, with the server 900 configured to operate the server-operating method 600 depicted in FIG. 1.

The server 900 is configured to match a request (also called a request offer) received from a requester-mobile device 102 (to be used by a consumer also called a requestor) with a fulfilment offer received from a fulfiller-mobile device 108 (to be used by a supplier also called a fulfiller). The requester-mobile device 102 and the fulfiller-mobile device 108 includes a smart phone, a tablet computer or any type of portable computing device (and any equivalent thereof) that can be network connected to the Internet (and any equivalent thereof). The request is an indication that indicates a request to purchase or obtain a product or a service. The fulfilment offer is an indication that indicates a fulfillment offer to provide a product or a service). The requester-mobile device 102 includes an application (software) configured to: (A) receive the request from the consumer (the requestor), and (B) transmit the request received from the consumer to the server 900 (via the Internet). The fulfiller-mobile device 108 includes an application (software) configured to receive the fulfilment offer from the fulfiller (the supplier), and also configured to transmit the fulfilment offer received from the supplier to the server 900 (via the Internet).

It will be appreciated that the requester-mobile device 102 and the fulfiller-mobile device 108 may be connected to the Internet via a stationary Internet connection (such as, connected to the Internet via a WiFi (TRADEMARK) connection provided at a café, restaurant, any place of business and/or leisure, etc.). It will be appreciated that the requester-mobile device 102 and the fulfiller-mobile device 108 may be connected to the Internet via a movable Internet connection (such as, connected to the Internet via a WiFi (TRADEMARK) connection provided by a movable vehicle, etc.).

The server 900 is configured to receive the request from the requester-mobile device 102, and to receive requestor position data (such as GPS coordinates) of the requester-mobile device 102 (as well) from the requester-mobile device 102. The server 900 is configured to receive the fulfilment offer from the fulfiller-mobile device 108, and to receive fulfiller position data (such as GPS coordinates) of the fulfiller-mobile device 108 (as well) from the fulfiller-mobile device 108.

The server 900 is configured to determine whether there is a match between the requestor position data of the requester-mobile device 102 and the fulfiller position data of the fulfiller-mobile device 108 (at any given predetermined moment in time, etc.). For the case where the server 900 determines there is a match between the requestor position data (of the requester-mobile device 102) and the fulfiller position data (of the fulfiller-mobile device 108), the server 900 is further configured to determine whether there is a match between the request of the requester-mobile device 102 and the fulfilment offer of the fulfiller-mobile device 108 (because the position data was matched up within a predetermined distance tolerance). The predetermined distance tolerance is an amount of positional distance (for example 100 feet) between the requester-mobile device 102 and the fulfiller-mobile device 108 for which a positional match may be determined by the server 900.

For the case here the server 900 determines that the requester-mobile device 102 and the fulfiller-mobile device 108 are positioned proximate to each other (that is, within an acceptable distance between the requester-mobile device 102 and the fulfiller-mobile device 108), the server 900 is further configured to determine whether there is a match between the request (provided by the requester-mobile device 102) and the fulfilment offer (provided by the fulfiller-mobile device 108).

For the case where the server 900 determines that there is a match between the positions of the requester-mobile device 102 and the fulfiller-mobile device 108 and that there is a match between the request of the requester-mobile device 102 and the fulfilment of the fulfiller-mobile device 108, the server 900 is further configured to transmit a match notification to both the requester-mobile device 102 and the fulfiller-mobile device 108.

Once the match notifications have been received by the requester-mobile device 102 and the fulfiller-mobile device 108, the user of the requester-mobile device 102 and the user of the fulfiller-mobile device 108 may then decide to seek each other out and consider making a transaction that may satisfy the request (of the requestor or consumer) and the fulfiller (the supplier or merchant). It is then left to the consumer and supplier to negotiate to close the deal or otherwise. For the case where a deal is made between the consumer and the supplier, then the requester-mobile device 102 may be updated by the consumer to remove the pending request from requester-mobile device 102 (with a subsequent update to the server 900). For the case where a deal is made between the consumer and the supplier, then the fulfiller-mobile device 108 may be updated by the supplier to remove the pending fulfilment offer from fulfiller-mobile device 108 (with a subsequent update to the server 900).

The technical effect of the server 900 is that the server 900 tracks, in use, the positions of the requester-mobile device 102 and the fulfiller-mobile device 108 and attempts to determine matches where possible between the request and the fulfillment offer. This is very convenient for the requestor (consumer) because the requestor does not have to be continually seeking fulfillment for their request (one of more requests) because the server 900 is configured to seek potential matches (while users go about their daily chores). As well, the supplier (fulfiller) does not have to be continually seeking a consumer that they can fulfill with their offering (one or more offerings) because the server 900 is configured to seek potential matches (while users go about their daily chores).

Generally, the request provided by the requester-mobile device 102 to the server 900 is matched with the fulfillment offer provided by the fulfiller-mobile device 108 to the server 900 based on a match between the positions of the requester-mobile device 102 and the fulfiller-mobile device 108 (within an acceptable tolerance), and also based a match between the content of the request and the fulfillment offer. The server 900 is configured to transmit a match notification to the requester-mobile device 102 and to the fulfiller-mobile device 108 once the two types of matches are identified by the server 900.

In accordance with an embodiment, a request (request offer) is received by the fulfiller-mobile device 108 (via a keyboard, etc.) with the request offer representing a service or product desired by a consumer (that is, the user of the requester-mobile device 102). A fulfillment offer is received by the fulfiller-mobile device 108 (via a keyboard, etc.) with the fulfillment offer representing a service or product that is offered by a supplier or a fulfiller (that is, the user of the fulfiller-mobile device 108). The request and the fulfillment offer are transmitted over the Internet (a network) to the server 900 for processing (making matches where possible). The positional location of the requester-mobile device 102 and the positional location of the fulfiller-mobile device 108 are transmitted from the requester-mobile device 102 and the fulfiller-mobile device 108 provided to the server 900. The server 900 is configured to compute whether the location of the requester-mobile device 102 and the fulfiller-mobile device 108 are within an acceptable distance of each other, and is also configured to compute whether the request matches the fulfillment offer, the server 900 issues (transmits) a match notification to the requester-mobile device 102 and/or to the fulfiller-mobile device 108 (for subsequent display to the users of the requester-mobile device 102 and/or the fulfiller-mobile device 108).

In accordance with the embodiments as depicted in FIG. 1 and FIGS. 2A to 2C, the server-operating method 600 (depicted in FIG. 1) is for operating the server 900 that is connectable to the network 902.

The server-operating method 600 includes receiving, via the network 902, a request offer 300 from a requester-mobile device 102. The method also includes receiving, via the network 902, a fulfilment offer 302 from a fulfiller-mobile device 108. The current requester location 200 (or simply the requester location 200) of the requester-mobile device 102 is intermittently determined, as is the current fulfiller location 202 (or simply the fulfiller location 202) of the fulfiller-mobile device 108. It is then determined whether the current requester location 200 of the requester-mobile device 102 is within a distance 106 from the current fulfiller location 202. The distance 106 represents a physical distance (measurable in feet, etc.). A match notification 104 is generated (by the server 900). The match notification 104 includes a match notification 304, and is issued by the server 900 for the case where: (A) a determination of made (by the server 900) in which the request offer 300 from the requester-mobile device 102 matches the fulfilment offer 302; and (B) a determination is made (by the server 900) in which the current requester location 200 of the requester-mobile device 102 is within the distance 106 from the current fulfiller location 202. The mobile-device match notification is displayed on the requester-mobile device 102. The match notification that was generated for display (on the mobile device) can also be transmitted via the network 902, to any one of the requester-mobile device 102 and the fulfiller-mobile device 108.

In accordance with the embodiments as depicted in FIG. 2A, the requester-mobile device 102 accepts an input for a request offer 300 through the requester input device 400. The request offer 300 is then sent via the network 902 to the server 900 where it is stored in a data store.

Similarly, the fulfiller-mobile device 108 accepts an input for a fulfilment offer 302 through the fulfiller input device 500 (of the fulfiller-mobile device 108). The fulfilment offer 302 is then sent via the network 902 to the server 900 where it is stored in the same data store that stores the request offer 300.

In accordance with the embodiments as depicted in FIG. 2B, the requester-mobile device 102 receives, via the requester locator device 406, its current requester location 200. This current requester location 200 is sent via the network 902 to the server 900 where it is stored in the same data store that stores the request offer 300 and the fulfilment offer 302.

Similarly, the fulfiller-mobile device 108 receives, via the fulfiller locator device 506, its current fulfiller location 202. This current fulfiller location 202 is sent via the network 902 to the server 900 where it is stored in the same data store that stores the current requester location 200.

In accordance with the embodiments as depicted in FIG. 2B, the current requester location 200 and the current fulfiller location 202 indicate that the requester-mobile device 102 and the fulfiller-mobile device 108 are outside of a distance 106. It is noted that this distance 106 is arbitrary and may be configurable (predetermined, etc.). In an embodiment, a system administrator may set a distance value to be used for all matches. Each of the request offers 300 and the fulfilment offers 302 contains (includes) distance information (positional information of the requester-mobile device 102 and the fulfiller-mobile device 108) that can be used by the server 900 to determine there is a potential match that may be reported out to the requester-mobile device 102 and/or to the fulfiller-mobile device 108.

Preferably, the request offer 300, the fulfilment offer 302, the current requester location 200, and the current fulfiller location 202 may be stored on separate data stores (databases) that are in communication with one another. This may be done for the purposes of redundancy, efficiency, or speed, etc.

In accordance with the embodiments as depicted in FIG. 2C, the server 900 is configured to match the request offers 300 from the requester-mobile device 102 with the fulfilment offers 302 from the fulfiller-mobile device 108. In an embodiment, the server 900 is configured to query the data store containing the request offers 300 and the fulfilment offers 302 in order to determine if any of the request offers 300 match with any of the fulfilment offers 302. Embodiments of the criteria used to match the request offers 300 with the fulfilment offers 302 include, but are not limited to, the product or service contained in the respective offers, whether the request price range and the fulfillment price range overlap, whether the request offer 300 and fulfilment offer 302 originate from the same geographical location (e.g., state, city, neighborhood), the distance between the location of a requester-mobile device 102 and the location of the fulfiller-mobile device 108, and other criteria that could be used to match a request to an offer.

In accordance with another embodiment, the request offer 300 and the fulfilment offer 302 are stored as files in the data store. A parser (known and not shown) parses the files and compares the criteria contained in the request offer 300 and the fulfilment offer 302.

In accordance with an embodiment of the distance between the location of a requester-mobile device 102 and the location of the fulfiller-mobile device 108, each of the requester-mobile device 102 and the fulfiller-mobile device 108 sends its location information, as obtained from their respective location devices, to the server 900.

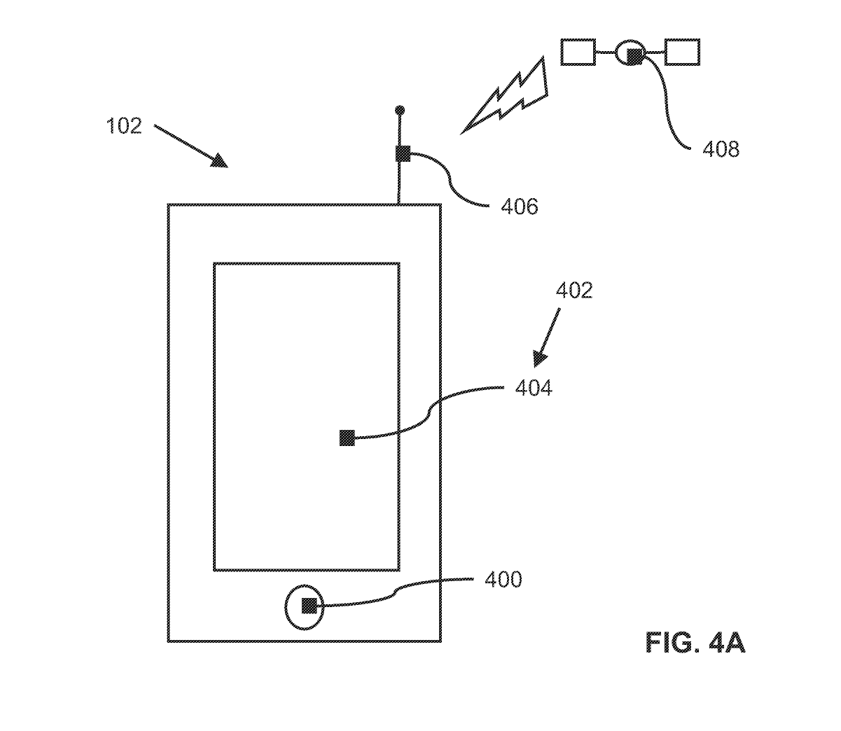

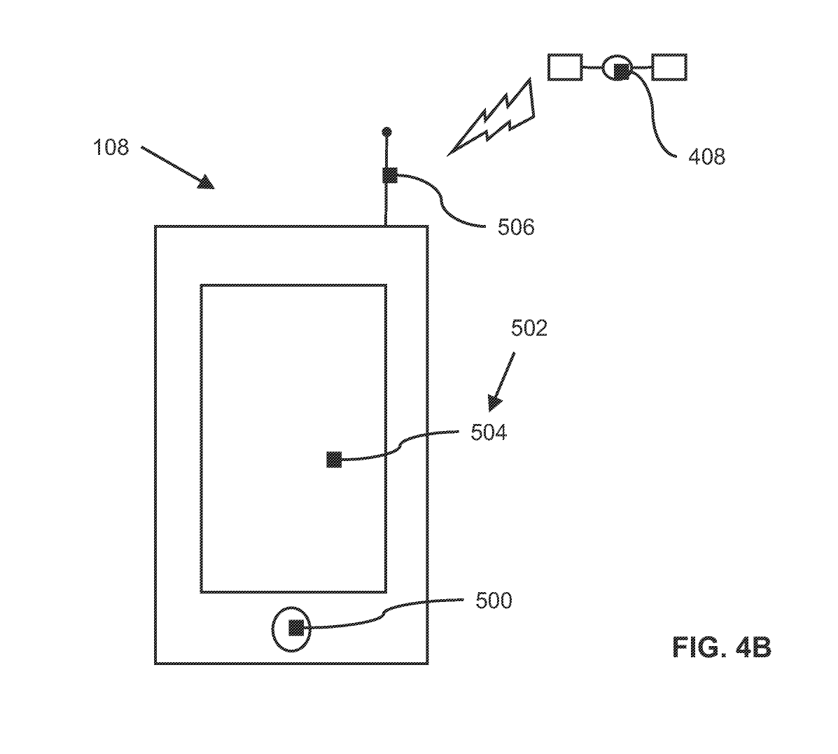

In accordance with the embodiments as depicted in FIG. 2C, the server 900 determines a match between the request offer 300 and the fulfilment offer 302. The server 900 also determines that the current requester location 200 is within a distance 106 of the current fulfiller location 202. Once the appropriate match and distance criteria are met, the server 900 generates a match notification 104 for display on the requester-mobile device 102. In accordance with the embodiment as depicted in FIG. 2C, the match notification 104 is sent via the network 902 to each of the requester-mobile device 102 and the fulfiller-mobile device 108. The requester-mobile device 102 and the fulfiller-mobile device 108 then display the match notification 104 through their respective instances of the fulfiller notification device 402 (as depicted in FIG. 4A) and instances of the fulfiller notification device 502 (as depicted in FIG. 4B)

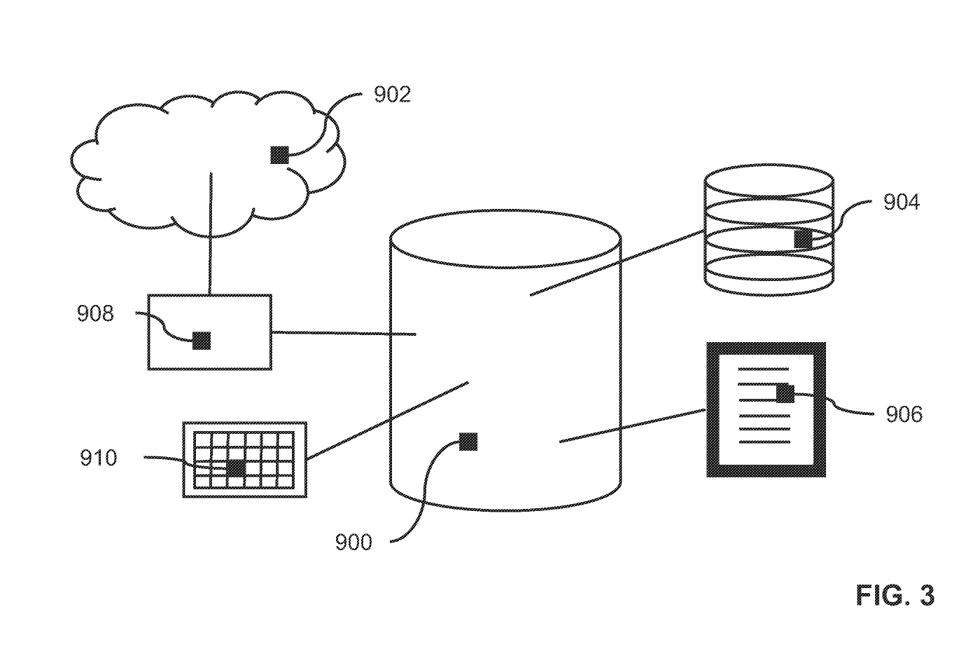

FIG. 3 depicts a schematic view of an embodiment of the server 900 of any one of FIGS. 2A, 2B and 2C.

In accordance with the embodiments as depicted in FIG. 3, the server 900 is a computer having an input device 910, a storage device 904 (also called a data store), a display 906, a memory (not shown), a processor (not shown), and a network connection device 908 to connect to a network 902.

The server 900 is configured to receive request offers 300 and fulfilment offers 302 through (via) the network 902 (the Internet) and store them in the storage device 904. The server 900 is also configured to receive the current requester location 200 of the requester-mobile device 102 and the current fulfiller location 202 of the fulfiller-mobile device 108 through the network 902 and store them in the storage device 904.

The server 900 is also configured to match the request offers 300 with the fulfilment offers 302. In an embodiment, the request offer 300 and the fulfilment offer 302 will contain data that can be matched. This can include, but is not limited to, a name of a product or service, a description of a product or service, a price range for the product or service that is acceptable to the requestor, a price range for the product or service that is acceptable to the fulfiller, a distance that the requestor is willing to travel to fulfill the product or service, and a distance that the fulfiller is willing to travel to fulfill the product or service.

The server 900 is also configured to determine whether the current requester location 200 is within a distance 106 of the current fulfiller location 202. In an embodiment, once the server 900 receives the current requester location 200 and the current fulfiller location 202, the server determines the distance between the current requester location 200 and the current fulfiller location 202. In an embodiment where the WGS 84 Web Mercator coordinate system is used (and any equivalent thereof), the distance between the current requester location 200 and the current fulfiller location 202 can be determined by calculating the distance between the two points. This distance can then be compared against the distance 106. In some embodiments, the distance 106 may be determined by taking the largest overlapping maximum distance criteria in both the request offers 300 and the fulfilment offers 302. In other embodiments, the distance 106 may be an arbitrary and adjustable system-wide value based on how users are using the system.

The Web Mercator, the Google Web Mercator, the Spherical Mercator, the WGS 84 Web Mercator and the WGS 84/Pseudo-Mercator are variations of the Mercator projection (the de facto standard for Web mapping applications, which are known and not described here).

Once (A) the server 900 matches a request offer 300 with a fulfilment offer 302, and (B) the server 900 determines that the calculated distance between the current requester location 200 and the current fulfiller location 202 is less than or equal to the distance 106 specified in the server, then the server 900 generates a match notification 104. In an embodiment, the match notification 104 can be a message that is generated at the server for display on any one of the requester-mobile device 102 or the fulfiller-mobile device 108. In another embodiment, the match notification 104 may be an SMS message that is sent directly to any one of the requester-mobile device 102 or the fulfiller-mobile device 108

This match notification 104 is then transmitted to any one of the requester-mobile device 102 and the fulfiller-mobile device 108 through the network 902.

The server 900 is connected to the network 902 (such as, the Internet) for communicating with the requester-mobile device 102 and the fulfiller-mobile device 108. In some instances, the server 900 may be connected to the Internet through a physical connection such as an Ethernet connection through a network connection device 908 such as an Ethernet network interface card, as shown in FIG. 3. In other instances the server 900 may be connected to the Internet wirelessly, such as through a WiFi (TRADEMARK) connection or a cellular network.

In another embodiment, the server 900 may also be a virtual machine (or instance) operating in a cloud-computing environment, the virtual machine running on a computer administered by the cloud-computing environment administrator.

In yet another embodiment, the server 900 may be implemented on a distributed system having multiple servers in order to handle bandwidth, capacity, or performance issues.

FIGS. 4A and 4B depict schematic views of embodiments of devices associated with the server-operating method 600 depicted in FIG. 1.

requester-mobile device 102

In accordance with the embodiments as depicted in FIG. 4A, the requester-mobile device 102 can be any portable computing device that can connect to the Internet. Embodiments of such a requester-mobile device 102 include a smartphone that can connect to the Internet through a cellular network. Another embodiment includes a tablet computer that can connect to the Internet through a wireless network such as a WiFi (TRADEMARK) connection.

The requester-mobile device 102 has a requester input device 400 configured to accept user inputs. Embodiments of such an input device include touchscreen displays 404, keypads (known and not depicted), keyboards (known and not depicted), and buttons (known and not depicted), etc.

In accordance with the embodiments as depicted in FIG. 4A, the requester-mobile device 102 has a fulfiller notification device 402 capable of providing notifications to the user. These notifications can be visual, auditory, vibratory, or any other way of providing a notification to the user. Embodiments of such notification devices can include touchscreen displays 404, buzzers (not depicted), speakers (not depicted), and vibration motors (not depicted).

In accordance with the embodiments as depicted in FIG. 4A, the requester-mobile device 102 has a requester locator device 406 for determining a current requester location 200 of the requester-mobile device 102. The requester locator device 406 is used to obtain the current physical location of the requester-mobile device 102. Embodiments of such a requester locator device 406 include a Global Positioning System (GPS) receiver configured to receive location data from a GPS satellite system 408. Another embodiment of a requester locator device 406 includes a wireless radio configured to receive and determine location information from the nearest wireless base station.

In an embodiment, the requester locator device 406 is configured to provide the current location of the requester-mobile device 102 to the requester-mobile device 102 on an intermit basis. The rate at which the requester locator device 406 provides current location information can be adjusted depending on various factors including, for instance, the speed at which the requester-mobile device 102 is moving, the remaining battery life of the requester-mobile device 102, and any mobile data capacity limitations imposed by a wireless communications provider. In another embodiment, the requester locator device 406 may be configured to provide the current location of the requester-mobile device 102 continuously. In yet another embodiment, the requester locator device 406 may be configured to provide the current location of the requester-mobile device 102 on an on-demand basis. The location of the requester-mobile device 102 is sent to the server 900 for further processing.

In accordance with the embodiments as depicted in FIG. 4B, a fulfiller-mobile device 108 is any portable computing device that can connect to the Internet. An embodiment of such a fulfiller-mobile device 108 includes a smartphone that can connect to the Internet through a cellular network. Other embodiments include a tablet computer that can connect to the Internet through a wireless network such as a WiFi (TRADEMARK) connection (to the Internet), and a personal computer connected to the Internet through a wired network, etc.

The fulfiller-mobile device 108 has the fulfiller input device 500 configured to accept an input (from the user). Embodiments of such an input device include touchscreens 504, keypads, keyboards, and buttons (all known and not depicted).

The fulfiller-mobile device 108 has a fulfiller notification device 502 configured to provide a notification to the user. These notifications can be visual, auditory, vibratory, or any other way of providing a notification to the user. Embodiments of such notification devices can include touchscreen displays 504, buzzers (not depicted), speakers (not depicted), and vibration motors (not depicted).

The fulfiller-mobile device 108 has a fulfiller locator device 506 for determining a current fulfiller location 202 of the fulfiller-mobile device 108. The fulfiller locator device 506 is used to obtain the current physical location of the fulfiller-mobile device 108. Embodiments of such a fulfiller locator device 506 include a Global Positioning System (GPS) receiver configured to receive location data from a GPS satellite system 408. Another embodiment of a fulfiller locator device 506 includes a wireless radio configured to receive and determine location information from the nearest wireless base station.

In an embodiment, the fulfiller locator device 506 is configured to provide the current location of the fulfiller-mobile device 108 to the fulfiller-mobile device 108 intermittently. The rate at which the fulfiller locator device 506 provides current location information can be adjusted depending on various factors including, for instance, the speed at which the fulfiller-mobile device 108 is moving, the remaining battery life of the fulfiller-mobile device 108, and any mobile data capacity limitations imposed by a wireless communications provider. In another embodiment, the fulfiller locator device 506 may be configured to provide the current location of the fulfiller-mobile device 108 continuously. In yet another embodiment, the fulfiller locator device 506 may be configured to provide the current location of the fulfiller-mobile device 108 on an on-demand basis. The location of the fulfiller-mobile device 108 is sent to the server 900 for further processing.

A request offer 300 represents a product or service that a user would like fulfilled. In an embodiment, a request offer 300 can be a file containing information required to fulfill a request. This information can include, but is not limited to, requestor identification information, the product or service requested, the price range the requestor is willing to pay, the general geographical location of the requester (e.g., state, city, neighborhood), the maximum distance the user is willing to travel to fulfill the request, and any other information required to fulfill the request. This file can be stored in memory or on a storage medium such as a magnetic or solid-state drive locally on the requester-mobile device 102 and remotely on the server 900.

In another embodiment, the request offer 300 information is stored in a data store locally on the requester-mobile device 102 and remotely on the server 900. Embodiments of a data store include, but are not limited to, databases.

A fulfilment offer 302 represents a product or service that a fulfiller is offering to fulfill. The fulfilment offer 302 includes a file containing information required to fulfill a request. This information can include, but is not limited to, fulfiller identification information, the product or service that is being offered to be fulfilled, the price range the fulfiller is willing to charge for the provision of the product or service, the general geographical location of the fulfiller (e.g., state, city, neighborhood), the maximum distance the user is willing to travel to fulfill the request, and any other information required to fulfill the request. This file can be stored in memory or on a storage medium such as a magnetic or solid-state drive locally on the fulfiller-mobile device 108 and remotely on the server 900.

In another embodiment, the fulfilment offer 302 is information that is stored in a data store locally on the fulfiller-mobile device 108 and remotely on the server 900. Embodiments of a data store include, but are not limited to, databases.

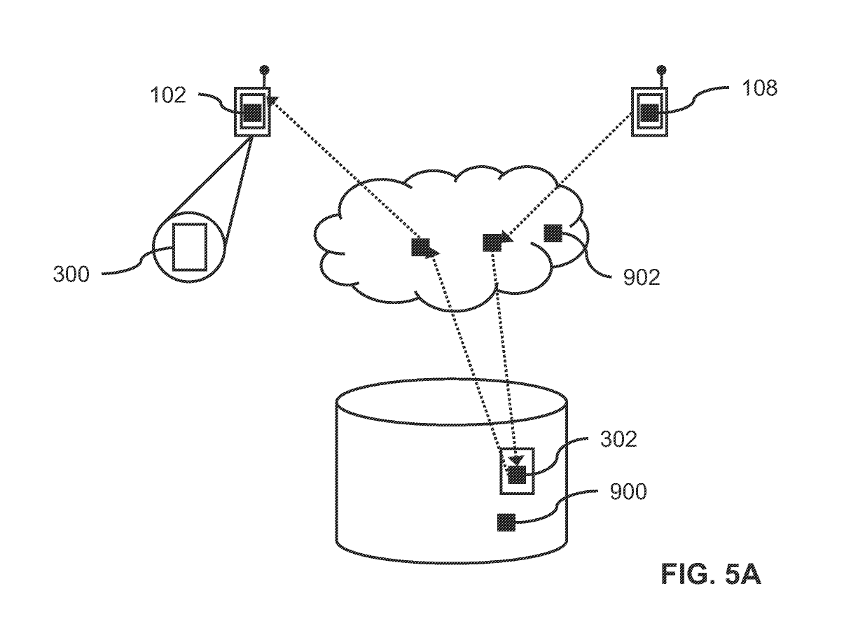

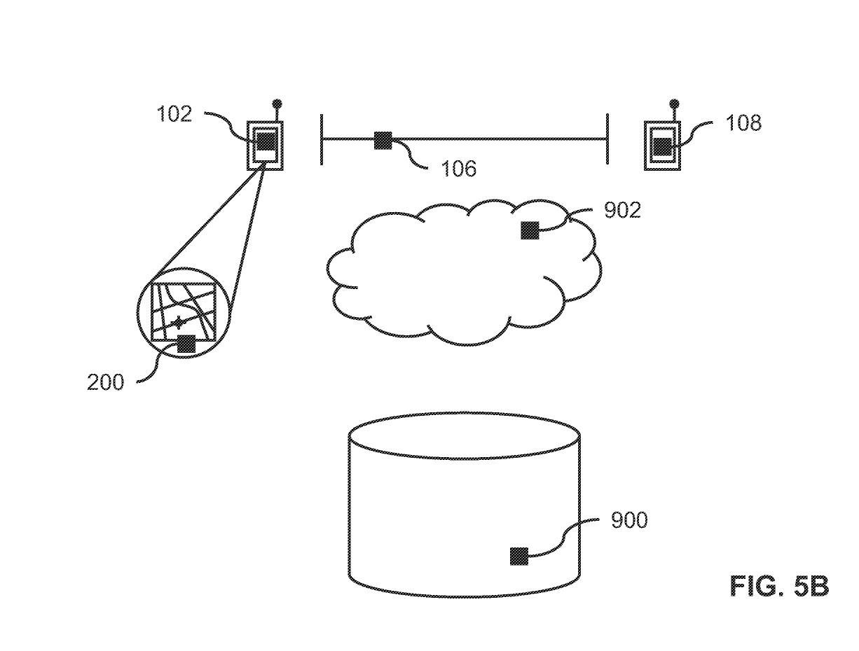

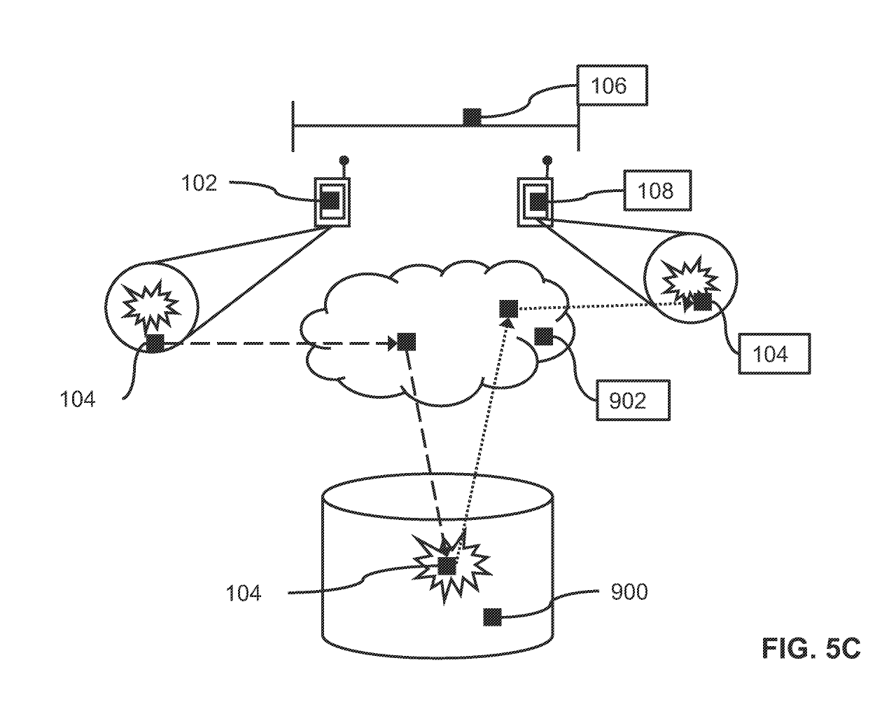

FIGS. 5A, 5B and 5C depict schematic views of an alternate embodiment of the server 900 of any one of FIGS. 2A, 2B and 2C.

In accordance with the alternative embodiments as depicted in FIGS. 5A, 5B and 5C, a portion of the server 900 functionality is offloaded to the requester-mobile device 102. This alternate implementation can be useful to reduce the resources required to operate the server 900. This alternate implementation also allows the system to continue operating even when access to a network 902 is limited.

In accordance with the embodiments as depicted in FIG. 5A, a fulfiller-mobile device 108 accepts an input for a fulfilment offer 302 through the fulfiller input device 500 (of the fulfiller-mobile device 108). The fulfillment offer should include the location of the fulfiller-mobile device 108. The fulfilment offer 302 is then sent via the network 902 to the server 900 where it is stored in the data store.

The fulfilment offer 302 is then forwarded to the requester-mobile device 102 and is stored on the requester-mobile device 102. In this embodiment, instead of generating a request offer 300, the user selects from a list of products or services generated by summarizing the instances of the fulfilment offer 302 currently on the requester-mobile device 102.

In accordance with the embodiments as depicted in FIG. 5B, the requester-mobile device 102 receives, via the requester locator device 406, its current requester location 200.

The requester-mobile device 102 is configured to match the fulfilment offer 302 with the product or service selected on the requester-mobile device 102. The requester-mobile device 102 is also configured to determine whether the current requester location 200 is within a distance 106 of the current fulfiller location 202. In an embodiment where the WGS 84 Web Mercator coordinate system is used, the distance between the current requester location 200 and the current fulfiller location 202 can be determined by calculating the distance between the two points. This distance can then be compared against the distance 106. In this embodiment, the maximum distance the requester is willing to travel to fulfill the offer would be used to determine whether the current requester location 200 is within a distance 106 of the current fulfiller location 202.

In accordance with the embodiments as depicted in FIG. 5C, once (A) the requester-mobile device 102 matches a fulfilment offer 302, and (B) the requester-mobile device 102 determines that the calculated distance between the current requester location 200 and the current fulfiller location 202 is less than or equal to the distance 106, then the requester-mobile device 102 generates a match notification 104. In an embodiment, the match notification 104 can be a message that is generated at the requester-mobile device 102 for display on the fulfiller-mobile device 108. In another embodiment, the match notification 104 may be an SMS message that is sent directly to the fulfiller-mobile device 108. The match notification 104 can be displayed on the requester-mobile device 102 through its fulfiller notification device 402 as depicted in FIG. 4A.

The requester-mobile device 102 then sends the match notification 104 to the server 900 via the network 902. The server then forwards the match notification 104 to the fulfiller-mobile device 108. The fulfiller-mobile device 108 then displays the match notification 104 through its fulfiller notification device 502 as depicted in FIG. 4B.

The server 900 is connectable to the network 902. The server 900 includes a processor assembly. The server 900 also includes a memory unit tangibly embodying processor-executable code configured to urge the processor assembly to execute the operations as described above in connection with the server 900. The server 900 includes controller-executable instructions configured to operate the server 900 in accordance with the description provided above. The server 900 may use computer software, or just software, which is a collection of computer programs (controller-executable instructions) and related data that provide the instructions for instructing the server 900 what to do and how to do it. In other words, software is a set of computer programs (tangibly embodied in a memory unit) configured to urge the ever 900 o execute the operations described above. Software refers to one or more computer programs and data held in a storage assembly (a memory module) of the controller assembly for some purposes. In other words, software is a set of programs, procedures, algorithms and its documentation. Program software performs the function of the program it implements, either by directly providing instructions to computer hardware or by serving as input to another piece of software. In computing, an executable file (executable instructions) causes the server 900 to perform indicated tasks according to encoded instructions, as opposed to a data file that must be parsed by a program to be meaningful. These instructions are machine-code instructions for a physical central processing unit. However, in a more general sense, a file containing instructions (such as bytecode) for a software interpreter may also be considered executable; even a scripting language source file may therefore be considered executable in this sense. While an executable file can be hand-coded in machine language, it is far more usual to develop software as source code in a high-level language understood by humans, or in some cases, an assembly language more complex for humans but more closely associated with machine code instructions. The high-level language is compiled into either an executable machine code file or a non-executable machine-code object file; the equivalent process on assembly language source code is called assembly. Several object files are linked to create the executable. The same source code can be compiled to run under different operating systems, usually with minor operating-system-dependent features inserted in the source code to modify compilation according to the target. Conversion of existing source code for a different platform is called porting. Assembly-language source code and executable programs are may not be transportable in this way. An executable includes machine code for a particular processor or family of processors. Machine-code instructions for different processors may be completely different and executables may be incompatible. Some dependence on the particular hardware, such as a particular graphics card may be coded into the executable. It is usual as far as possible to remove such dependencies from executable programs designed to run on a variety of different hardware, instead installing hardware-dependent device drivers on the server 900, which the program interacts with in a standardized way. Some operating systems designate executable files by filename extension (such as .exe) or noted alongside the file in its metadata (such as by marking an execute permission in Unix-like operating systems). Most also check that the file has a valid executable file format to safeguard against random bit sequences inadvertently being run as instructions. Modern operating systems retain control over the resources of the server 900, requiring that individual programs make system calls to access privileged resources. Since each operating system family features its own system call architecture, executable files are generally tied to specific operating systems, or families of operating systems. There are many tools (development tools) available that make executable files made for one operating system work on another one by implementing a similar or compatible application binary interface. When the binary interface of the hardware the executable was compiled for differs from the binary interface on which the executable is run, the program that does this translation is called an emulator. Different files that can execute but may not necessarily conform to a specific hardware binary interface, or instruction set, can be represented either in bytecode for Just-in-time compilation, or in source code for use in a scripting language.

This written description uses examples to disclose the invention, including the best mode, and also to enable any person skilled in the art to make and use the invention. The patentable scope of the invention is defined by the claims, and may include other examples that occur to those skilled in the art. Such other examples are within the scope of the claims if they have structural elements that do not differ from the literal language of the claims, or if they include equivalent structural elements with insubstantial differences from the literal language of the claims.

It may be appreciated that the assemblies and modules described above may be connected with each other as required to perform desired functions and tasks within the scope of persons of skill in the art to make such combinations and permutations without having to describe each and every one in explicit terms. There is no particular assembly or component that may be superior to any of the equivalents available to the person skilled in the art. There is no particular mode of practicing the disclosed subject matter that is superior to others, so long as the functions may be performed. It is believed that all the crucial aspects of the disclosed subject matter have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) the description provided outside of this document (that is, outside of the instant application as filed, as prosecuted, and/or as granted). It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. A server-operating method of operating a server connectable to a network, the server-operating method comprising:
instructing the server to:
receive, via the network, a request offer from a requester-mobile device;
receive, via the network, a fulfilment offer from a fulfiller-mobile device;
receive, via the network, a requester location of the requester-mobile device;
receive, via the network, a fulfiller location of the fulfiller-mobile device;
determine whether the requester location of the requester-mobile device is within a distance from the fulfiller location of the fulfiller-mobile device;
generate a match notification for display on the requester-mobile device for where:
the request offer from the requester-mobile device matches the fulfilment offer; and
the requester location of the requester-mobile device is within the distance from the fulfiller location; and
transmit, via the network, the match notification that was generated for display to any one of the requester-mobile device and the fulfiller-mobile device.

2. The server-operating method of claim 1, further comprising:
instructing the server to:
track positions of the requester-mobile device and the fulfiller-mobile device; and
determine matches where possible between a request and a fulfillment offer provided by the requester-mobile device and the fulfiller-mobile device, respectively.

3. The server-operating method of claim 1, further comprising:
instructing the server to:
compute whether a location of the requester-mobile device and the fulfiller-mobile device are within an acceptable distance of each other;
compute whether a request does match a fulfillment offer;
transmit the match notification to any one of the requester-mobile device and the fulfiller-mobile device for subsequent display on the requester-mobile device or the fulfiller-mobile device.

4. The server-operating method of claim 1, wherein:
each of the request offer and the fulfilment offer includes positional information of the requester-mobile device and the fulfiller-mobile device that is used by the server to determine there is a potential match that may be reported out to the requester-mobile device and/or to the fulfiller-mobile device.

5. The server-operating method of claim 1, wherein:
a criteria used by the server to match the request offer with the fulfilment offer includes any one of a type of a product or a type of a service contained in the respective offers, whether a request price range and a fulfillment price range, at least in part, overlap, whether the request offer and the fulfilment offer originate, at least in part, from the same geographical location, and the distance between the location of the requester-mobile device and the location of the fulfiller-mobile device.

6. The server-operating method of claim 1, wherein:
each of the requester-mobile device and the fulfiller-mobile device sends its location information, as obtained from their respective location devices, to the server.

7. The server-operating method of claim 1, further comprising:
instructing the server to:
determine whether a match exists between the request offer and the fulfilment offer;
determine whether the requester location is within an acceptable distance from the fulfiller location; and
generate, once a match criteria and a distance criteria are met, the match notification for display on the requester-mobile device, and the match notification is sent via the network to the requester-mobile device in such a way that the requester-mobile device displays the match notification.

8. The server-operating method of claim 1, further comprising:
instructing the server to match the request offer with the fulfilment offer by any one of a name of a product or a service, a description of the product or the service, a price range for the product or the service that is acceptable to a requestor, the price range for the product or the service that is acceptable to a fulfiller, the distance that the requestor is willing to travel to fulfill the product or the service, and the distance that the fulfiller is willing to travel to fulfill the product or the service.

9. The server-operating method of claim 1, wherein:
the requester-mobile device has a requester locator device for determining the requester location of the requester-mobile device; and
the requester locator device is used to obtain a physical location of the requester-mobile device;
the fulfiller-mobile device has a fulfiller locator device for determining the fulfiller location of the fulfiller-mobile device; and
the fulfiller locator device is used to obtain the physical location of the fulfiller-mobile device.

10. An apparatus, comprising:
a server being connectable to a network, the server including a processor assembly, and also including a memory unit tangibly embodying processor-executable code configured to urge the processor assembly to:
receive, via the network, a request offer from a requester-mobile device;
receive, via the network, a fulfilment offer from a fulfiller-mobile device;
receive, via the network, a requester location of the requester-mobile device;
receive, via the network, a fulfiller location of the fulfiller-mobile device;
determining whether the requester location of the requester-mobile device is within a distance from the fulfiller location of the fulfiller-mobile device;
generating a match notification for display on the requester-mobile device for where:
the request offer from the requester-mobile device matches the fulfilment offer; and
the requester location of the requester-mobile device is within the distance from the fulfiller location; and
transmitting, via the network, the match notification that was generated for display to any one of the requester-mobile device and the fulfiller-mobile device.

11. The apparatus of claim 10, wherein:
the server is configured to:
track positions of the requester-mobile device and the fulfiller-mobile device; and
determine matches where possible between a request and a fulfillment offer provided by the requester-mobile device and the fulfiller-mobile device, respectively.

12. The apparatus of claim 10, wherein:
the server is configured to:
compute whether a location of the requester-mobile device and the fulfiller-mobile device are within an acceptable distance of each other;
compute whether a request does match a fulfillment offer;
transmit the match notification to any one of the requester-mobile device and the fulfiller-mobile device for subsequent display on the requester-mobile device or the fulfiller-mobile device.

13. The apparatus of claim 10, wherein:
each of the request offer and the fulfilment offer includes positional information of the requester-mobile device and the fulfiller-mobile device that is used by the server to determine there is a potential match that may be reported out to the requester-mobile device and/or to the fulfiller-mobile device.

14. The apparatus of claim 10, wherein:
a criteria used by the server to match the request offer with the fulfilment offer includes any one of a type of a product or a type of a service contained in the respective offers, whether a request price range and a fulfillment price range, at least in part, overlap, whether the request offer and the fulfilment offer originate, at least in part, from the same geographical location, and the distance between the location of the requester-mobile device and the location of the fulfiller-mobile device.

15. The apparatus of claim 10, wherein:
each of the requester-mobile device and the fulfiller-mobile device sends its location information, as obtained from their respective location devices, to the server.

16. The apparatus of claim 10, wherein:
the server is configured to:
determine whether a match exists between the request offer and the fulfilment offer;
determine whether the requester location is within an acceptable distance from the fulfiller location; and
generate, once a match criteria and a distance criteria are met, the match notification for display on the requester-mobile device, and the match notification is sent via the network to the requester-mobile device in such a way that the requester-mobile device displays the match notification.

17. The apparatus of claim 10, wherein:
the server is configured to:
match the request offer with the fulfilment offer by any one of a name of a product or a service, a description of the product or the service, a price range for the product or the service that is acceptable to a requestor, the price range for the product or the service that is acceptable to a fulfiller, the distance that the requestor is willing to travel to fulfill the product or the service, and the distance that the fulfiller is willing to travel to fulfill the product or the service.

18. The apparatus of claim 10, wherein:
the requester-mobile device has a requester locator device for determining the requester location of the requester-mobile device; and
the requester locator device is used to obtain a physical location of the requester-mobile device;
the fulfiller-mobile device has a fulfiller locator device for determining the fulfiller location of the fulfiller-mobile device; and
the fulfiller locator device is used to obtain the physical location of the fulfiller-mobile device.
